(19) United States
(12) Patent Application Publication
(10) Pub. No.: US 2013/0000522 A1
(43) Pub. Date: Jan. 3, 2013

(54) CEMENTITIOUS MATERIAL PRODUCTION PROCESS, WITH THE USE OF OIL SHALES AND/OR RESIDUES OF ITS PROCESSING IN CEMENTATION FURNACE

(76) Inventors: Arnaldo Dias de Andrade, Minas Gerais (BR); Rene Ferreira Junior, Minas Gerais (BR); Giorgio Francesco Cesare de Tomi, Sao Paulo (BR); Alexandre Orlandi Passos, Sao Paulo (BR)

(21) Appl. No.: 13/530,193

(22) Filed: Jun. 22, 2012

(30) Foreign Application Priority Data
Jul. 1, 2011 (BR) PI1103563-3

(51) Int. Cl. C04B 7/30

(52) U.S. Cl. 106/803

(57) ABSTRACT

This process allows the attainment of cementitious materials and activated artificial pozzolana, developed as from shale oils and/or residues of its processing, hereinafter simply called “shale oil”, mixed among them and/or with clays when placed in the rotation oven, in proportion that vary from 1% to 100% of the shale oils in the mixture. These shale oils or mixtures of shale oil with clays, when burn in temperatures between 600° C. and 900° C., in a horizontal oven, in reducing conditions, generate the so called cementitious materials or activated artificial pozzolana, when in contact with the water, providing to the material agglomerating properties.

### FIELD OF THE INVENTION

Report describing the Invention Patent of process of production of cementitious material with the usage of oil shales, or pyrobetuminous shale, and/or residues of its processing in cementation furnace, aiming the attainment of a product largely used in the several types of industry, such as, for instance, civil works industry, the cement industry, as a material additional to cement (cementitious material), the concrete industry, as a material additional to the concrete, and the mortar industry, as material additional to the mortar.

### SUMMARY OF THE INVENTION

This process allows the attainment of cementitious and activated artificial pozzolana, developed as from oil shale and/or residues from its processing, hereinafter simply called “shale oil”, mixed among them, and/or with clay in the feeding of the rotational oven, in proportions that vary from 1% up to 100% of shale oil in the mixture. This shale oil or shale oil mixtures with clays, when burnt in temperatures between 600° C. and 900° C., in a horizontal oven, in a reducing environment, generate the so-called cementitious material or activated artificial pozzolana, which makes the cementitious material or the artificial pozzolana reactive, when in contact with the water, giving the material agglomerating properties.

### DESCRIPTION OF THE INVENTION

The process herein proposed consists of burning shale oil and/or mixings of this material with clays in a horizontal oven, and for such, both the shale oil and the shale oil and clay mixture shall be dosed by doser equipment and placed together in the oven.

Depending on the characteristic of the shale oil and/or of its mixing with clay, and also of the fuel used in the oven, the feeding proportion of shale oil varies from 1% up to 100%.

The oven's temperature, measured in the burning zone, shall be between 600° C. to 900° C.

The environment inside the oven shall be in reducing conditions, with the CO2 level varying, when leaving the oven, from 0.10 to 2.00%.

The staying time of the material in the oven shall be from 40 to 70 minutes.

The fuel used in the oven may be natural gas, cock, whether national or imported, crushed, crushed pulverized coal, crushed charcoal, crushed coal, diesel oil, heavy oils or gases from the gases generator.

The cementitious material or artificial pozzolana activated when leaving the oven may be cooled by air in counter-current, or cooled by the room temperature in a stock.

The quality control of the burnt shale oil and/or of the mixture of shale oil and clays produced in the horizontal oven is performed by the “loss on ignition” or “loss by burning” of the cementitious materials or artificial pozzolana activated when leaving the oven, which, depending on the shale oils and/or mixtures of shale oils and clays, may be from 0.50% to 11%.

In the burning in the horizontal oven, it may be used the shale oil from the Tremembé/SP formation, the shale oil from Irati formation (SP, PR, SC and RS), the retorted shale oil (residue from the processing of UN-SIX), smashed shale oil (residue of the processing of UN-SIX), the shale oil of the Candeias formation (BA and SE) or other shale oils with similar characteristics, alone or mixed among them and/or with clays.

The burnt shale oil is produced in the horizontal oven, at a temperature of 600° C. to 900° C., due to the composition of the natural material and to the production process.

The burnt shale oil contains clinker phases, especially dicalcium silicate and monocalcium aluminate. It also contains, besides small amounts of free calcium oxide and of calcium sulfate, higher amounts of oxides that pozzolanically react, especially silicium dioxide. Consequently, when firmly crushed, the burnt shale oil reveals strong hydraulic properties, such as Portland cement and, supplementary, pozzolanic properties.

The clay's and/or clays and shale oils mixture activity is due to the pozzolanic activity of the clay minerals, of the aluminum oxides of the gamma type and of the aluminum hydroxides, which shall be burnt to produce satisfactory pozzolanic properties. Some burnt clays are excellent pozzolans, especially clays containing Kaolinite and montmorillonite for the control of the alkali-aggregate.

The pozzolanic properties of the shale oils and/or of the shale oil mixtures and burnt clays are obtained at around 500° C., being the temperatures good between 600° C. to 900° C., and above 900° C., the pozzolanic activity of lost, due to the formation of stable crystalline compounds.

The clays used as pozzolanes usually contain from 50 to 65% of SiO₂ and from 17 to 38% of Al₂O₃. The pozzolanic activity increases as the AL₂O₃ content increases, which suggest that an aluminum compound contributes for the pozzolanic activity, probably forming a calcium aluminate. In favor of this fact, there is the characteristic of the burnt bauxite, rich in gamma aluminum oxide, which is an excellent pozzolanic material.

Due to the critical influence of the burning temperature in the clays' properties, the production shall be carefully controlled in order to obtain a uniform pozzolane. The variations of the pozzolanic activities of clays, in view of the temperature, are correlated to the structural variations that occur in the different clay minerals. These transformations are schematically represented by the equations:

3(Al2O3.2SiO2.2H2O) (400 to 700° C.)→6H2O+3(Al2O3.2SiO2)(metakaolin or metakaolinite) (975°C.)→Nucleation

The higher degree of crystalline disorder is on the Metakaolinite phase, containing alumina and silica with high specific area and with great chemical activity.

This way, it is reasonable to conclude that the component with pozzolanic activity in the case of burnt kaolinit clays is Metakaolinite, and that the product formed by the reaction between Metakaolinite and calcium hydroxide is, therefore, a mixture of silicates and calcium aluminates, possible hydrated. The non burnt kaolinit does not have any pozzolanic activity and it does not react with calcium hydroxide.

With the abovementioned process, we also have the reduction of Fe₂O₃, due to the carbon of the shale oil's fuel and of the reducing conditions in the oven, with the presence of CO. With this, there is a change in the color of the shale oils and/or shale oils mixtures and burnt clays in the rotational oven.

The cementitious material and the activated artificial pozzolane produced in the horizontal oven with the abovementioned method shall comply with the NBR 5736 standard—Pozzolanic Portland Cement, NBR 5737—sulfate-resistant Portland Cements, NBR 12653—Pozzolanic materials, NBR 5751—Pozzolanic materials—determination of the pozzolanic activity—Index of pozzolanic activity with lime, NBR 5752—Pozzolanic materials—Determination of pozzolanic activities with Portland cement—Index of pozzolanic activity with cement, and NBR 5753—Portland Cement—pozzolanicity tests for pozzolanic Portland cement.

1-13. (canceled)

14. A method for producing a cementitious material comprising the steps of:
burning at least one of shale oils and a mixture of shale oils and clays in a horizontal oven, wherein the shale oils and the mixture of shale oils and clays are placed together in the horizontal oven, and wherein the amount of shale oils is between 1% and 100% weight.

15. The method according to claim 14, wherein the horizontal oven is a temperature of between 600° C. and 900° C.

16. The method according to claim 14, wherein an environment inside the horizontal oven has reducing conditions having a CO level from 0.10 to 2.00%.

17. The method according to claim 14, wherein the shale oils are burned on the horizontal oven between 40 and 70 minutes.

18. The method according to claim 14, wherein a fuel is used in the horizontal oven, the fuel is selected from the group consisting of natural gas, coke, diesel oil, heavy oils, and gases from a generator.

19. The method according to claim 14, further including the step of activating the cementitious material after leaving the horizontal oven by cooling with an air counter current or cooling at room temperature at a stock.

20. The method according to claim 14, wherein the cementitious materials after the burning step has a loss on ignition or a loss by burning of between 0.50% and 11%.

21. The method according to claim 14, wherein the shale oil is selected from a Tremembé/SP formation, an Irati formation, a retorted shale oil, a smashed shale oil, a Candeias formation, or mixture thereof.

22. The method according to claim 14, wherein the burnt shale oil or the burnt mixture of shale oils and clays dicalcium silicate and monocalcium aluminate; traces of free calcium oxide; traces of calcium sulfate; and oxides that pozzolanically react including silicium dioxide.

23. The method according to claim 14, wherein when firmly crushed, the burnt shale oils has main properties of a portland cement and supplementary pozzolanic properties.

24. The method according to claim 14, wherein the burnt shale oils and the burnt mixture of shale oils and clays have pozzolanic activities based on a presence of clay minerals, gamma-aluminum oxides, and aluminum hydroxides.

25. The method according to claim 16, further including a reduction of Fe₂O₃ during the burning step by a carbon of the shale oil and the CO.

26. The method according to claim 14, wherein the clays contains from 50 to 65% of SiO₂ and from 17 to 38% of Al₂O₃.
